(19) United States
(12) Patent Application Publication
(10) Pub. No.: US 2022/0402283 A1
(43) Pub. Date: Dec. 22, 2022

(54) ALIGNMENT BAR METROLOGY FOR PRINTERS

(71) Applicant: HEWLETT-PACKARD DEVELOPMENT COMPANY, L.P., Spring, TX (US)

(72) Inventors: Josep TARRADAS I. JUAN, Sant Cugat del Valles (ES); Nestor LUID PINOL, Sant Cugat del Valles (ES); Ricard EJARQUE MONTALVO, Sant Cugat del Valles (ES)

(21) Appl. No.: 17/774,439

(22) PCT Filed: Jan. 28, 2020
(86) PCT No.: PCT/US2020/015421

§ 371 Date: May 4, 2022

(51) Int. Cl. B41J 13/32; B41J 11/46

(52) U.S. Cl. CPC B41J 13/32; B41J 11/46; B41J 2203/01

(57) ABSTRACT

A method, a printing device and a calibration module to check an alignment element of a printer by comparing a relative alignment of a calibration mark with respect to a reference mark, wherein the calibration mark indicates an alignment of the alignment element and the reference mark indicates an alignment of a printhead scanning direction of the printer.

### BACKGROUND

Alignment bars are used in printers, for instance in printers for large rigid print media, to guide or control the orientation of a print medium fed to the printer. Misalignment of the alignment bar, for example with respect to a direction of movement of the printheads, may result in skewed printing on the print medium. However, it may be difficult to identify when skewed printing is being caused by a misalignment of the alignment bar and not by other sources of error.

### BRIEF DESCRIPTION OF THE FIGURES

FIG. 1 is a schematic illustration showing a top view of a printing device according to an example.

FIG. 2 is a schematic illustration showing a front view of the example shown in FIG. 1.

FIG. 3 is a schematic illustration showing the front view shown in FIG. 2, wherein the position of the alignment element is shifted with respect to the situation illustrated in FIG. 2.

FIG. 4 is a schematic illustration showing a cross-sectional view of the example shown in FIG. 1.

FIG. 5 is a schematic illustration of a hand-held drawing device according to an example.

FIG. 6 is a schematic illustration of the use of a hand-held drawing device according to an example.

FIG. 7 is a schematic illustration of the use of a hand-held drawing device according to an example.

FIG. 8 is a schematic illustration showing a perspective view of a printing device according to an example.

FIG. 9 is a flow diagram schematically illustrating a method according to an example.

FIG. 10 is a schematic illustration of a printing process in a method according to an example.

FIG. 11 is a schematic illustration of a print medium used in a method according to an example.

FIG. 12 is a schematic illustration of a process of obtaining measurements in a method according to an example.

FIG. 13 is a schematic illustration showing a plot representing measurements in a method according to an example.

FIG. 14 is a schematic illustration showing a plot representing measurements in a method according to an example.

FIG. 15 is a schematic illustration showing a plot representing alignment values in a method according to an example.

### DETAILED DESCRIPTION

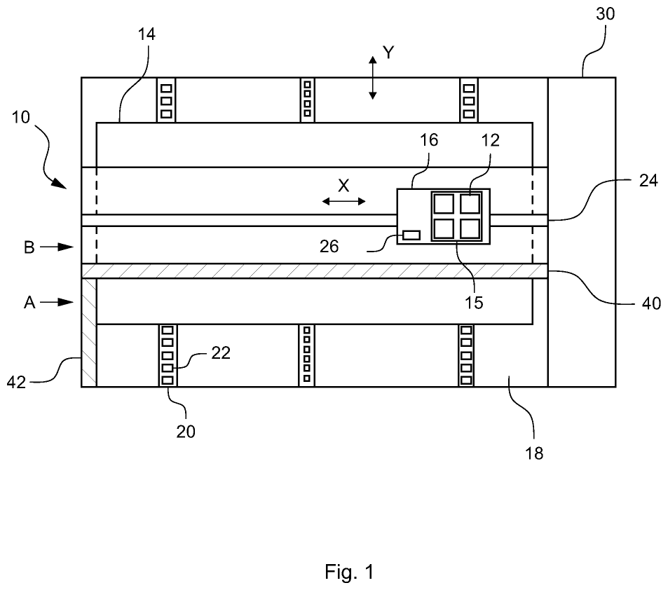

FIG. 1 is a schematic illustration showing a top view of a printing device 10 according to an example. The printing device 10 comprises a carriage 16, receiving at least one printhead 15 to print on a print medium 14. The print medium 14 may be a sheet of a printable rigid or flexible material such as paper, cardboard, metal, wood, glass or plastic. In the example shown in FIG. 1, the printhead 15 comprises four arrays of printing nozzles 12 to fire a printing fluid, such as ink, on the print medium 14. However, the number of printing nozzles 12 contained in the printhead 15 is not limited thereto and may be any number in this or other examples. In the example illustrated in FIG. 1, one printhead 15 is shown. However, the carriage 16 may comprise any number of printheads 15, in particular 2, 3, 4, 6, 8 or more printheads 15.

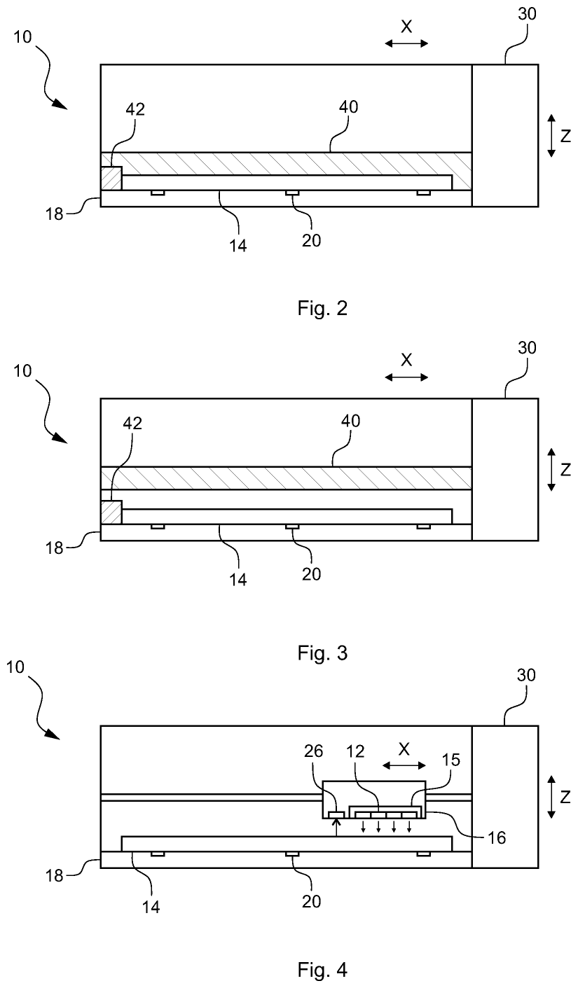

The printhead 15 is located in the printhead carriage 16 which is movable in a printhead scanning direction or printhead scanning direction XX, which in FIG. 2 corresponds to a horizontal direction. The movement of the carriage 16 in the printhead scanning direction X may be guided by a printhead bar 24, which extends in the printhead scanning direction X.

The print medium 14 may rest on a print medium supporting surface 18 of the printing device 10 and may be movable in a print medium movement direction or print medium advance direction Y, which in FIG. 1 corresponds to the vertical direction. The print medium movement direction Y may be substantially perpendicular to the printhead scanning direction X. In the example shown, the printing device 10 comprises roller guides 20 containing a plurality of roller elements 22. In some examples, the roller elements 22 may drive a movement of the print medium 14 in the print medium movement direction Y. However, in other examples the print medium 14 may be moved by other mechanism and the roller elements 22 may be non-driven roller elements or may not be present at all. A print zone is defined in an area below the carriage 16, across the entire width of the print medium supporting surface 18, in the printhead scanning direction X.

As the print medium 14 moves in the print medium movement direction Y and the carriage 16 moves in the printhead scanning direction X, the printhead 15 can reach any position of the print medium 14 or of a subregion thereof to print a predetermined image thereon using a printing fluid, for example ink.

In some examples, the print medium 14 may be moved, for a printing process, in the print medium movement direction Y backwards or forwards (i.e. downwards or upwards in the direction Y as depicted in FIG. 1), such that the print medium 14 crosses the print zone in a one-way movement in the Y-direction to be printed. In some examples, the print medium 14 may be moved, for a printing process, in the print medium movement direction Y backwards and forwards (i.e. downwards and upwards or vice versa in the direction Y as seen in FIG. 1), such that the print medium 14 moves in the print zone in a two-way movement in the Y-direction to be printed.

In some examples, a 2-axis print head carriage can be provided where the carriage and the at least one printhead received therein may further be movable in a direction perpendicular to the printhead scanning direction X, such that the printhead can scan and reach any position of the print medium 14 or of a subregion thereof, without the print medium 14 moving with respect to the print medium support surface 18.

In other examples, the printhead is not movable and may extend in the printhead scanning direction X, providing a page wide printhead array, for example. The printing device 10 can then possibly not comprise a movable carriage. In some examples, if the print medium 14 is to be printed across the entire print zone, the at least one printhead may extend in the printhead scanning direction X along a length corresponding at least to a dimension of the print medium 14 in the printhead scanning direction X. If a subregion of the print medium 14 is to be printed, the printhead may extend in the printhead scanning direction X along a length corresponding at least to a dimension of said subregion of the print medium 14 in the printhead scanning direction X. In these examples, any position of the print medium 14 or of a subregion thereof can be reached and printed by the non-movable printhead to print a predetermined image thereon using a printing fluid, for example ink.

The printing device 10 further comprises a line sensor 26 to perform optical measurements on the print medium 14. The line sensor may correspond to a typical line sensor included in a printer, for example to measure a position of the edges of the print medium and, additionally or alternatively, to measure contrast between image parts, for example lightness contrast or color contrast. As shown in FIG. 1, the line sensor 26 may be arranged on the carriage 16 and be hence movable in the printhead scanning direction X. The line sensor 26 may be arranged on a side of the carriage 16 facing the print medium 14. The line sensor 26 may be movable in the printhead scanning direction X to scan the print medium 14 or a subregion thereof.

In other examples, the line sensor 26 is possibly not movable in the printhead scanning direction X and may extend in the printhead scanning direction X across part of a print zone or across the entire print zone to scan the print medium 14 or a subregion thereof. According to some examples, if the at least one printhead 15 extends in the printhead scanning direction X, the line sensor 26 may extend parallel to the at least one printhead 15 covering at least the same length as the at least one printhead 15. More specifically, a page wide print bar may be paired with a page wide line sensor.

The printing device 10 further comprises a control unit 30 to control the operation of the carriage 16, the at least one printhead 15 and the line sensor 26. In some examples, the control unit 30 may control a movement of at least one of the carriage 16 and the line sensor 26 in the printhead scanning direction X. The control unit 30 may further control a movement of the print medium 14 in the print medium movement direction Y, for example by means of the roller guides 20 illustrated in FIG. 1.

The control unit 30 may comprise a processor, a CPU, or corresponding control electronics. In the example shown in FIG. 1, the control unit 30 is represented as an integral part of the printing device 10. However, the control unit 30 is possibly not an integral part of the printing device 10. In some examples, the control unit 30 may be an independent control unit connected to the printing device by means of a functional connection such as a wired connection, for example an Ethernet connection, or a wireless connection, for example a Wi-Fi connection.

The printing device 10 further comprises an alignment element 40 to register a position of the print medium 14 when the print medium 14 is received by the printing device 10. The alignment element 40 may for example be an alignment bar. The alignment element 40 extends in a direction substantially parallel to the printhead scanning direction X. The alignment element 40 may hence extend in a direction substantially perpendicular to the print medium movement direction Y.

The print medium 14 may be fed to the printing device 10 while resting on the print medium supporting surface 18. For the print medium to lay flat on the supporting surface 18, a vacuum can be applied to the bottom side of the print medium 14 via the supporting surface 18. The print medium 14 can be positioned such that a leading edge of the print medium 14 facing the alignment element 40 abuts the alignment element 40. Thereby, the alignment element 40 registers a position of the print medium 14 on the print medium supporting surface 18, in particular an orientation of the print medium 14, such that the aforesaid leading edge of the printing medium 14 be aligned with the alignment element 40.

As shown in the example illustrated in FIG. 1, the printing device 10 may optionally further comprise a lateral alignment element 42 to further register the position of the print medium 14. The lateral alignment element 42 may extend substantially perpendicular to the alignment element 40. The lateral alignment element 42 may extend substantially parallel to the print medium movement direction Y. When the print medium 14 is fed to the printing device 10, a lateral edge of the print medium 14 extending next to its leading edge and perpendicular thereto may come to rest against the lateral alignment element 42, such that the aforesaid lateral edge of the printing medium 14 abuts the lateral alignment element 42. Thereby, the lateral alignment element 42 may register the position of the print medium 14 on the print medium supporting surface 18.

FIGS. 2 and 3 are schematic illustrations of a vertical sectional view of the printing device 10 illustrated in FIG. 1 corresponding to cuts in the XZ-plane cut at a position indicated in FIG. 1 by an arrow A preceding the alignment element 40 in the print medium moving direction Y as seen from the bottom to the top of the figure. The alignment element 40 may be movable in a third direction Z perpendicular to the print medium movement direction Y and to the printhead scanning direction X. The third direction Z corresponds in FIGS. 2 and 3 to the vertical direction or direction of gravity. Moving the alignment element 40 in the third direction Z may allow adjusting a height of the alignment bar over the print medium supporting surface 18 and/or over the print medium 14. In other words, a distance between the alignment element 40 and the print medium 14 in the third direction Z can be adjusted by moving the alignment element 40 in the third direction Z.

The scenario illustrated in FIG. 2 may correspond to a feeding configuration, in which the alignment element 40 rests on the print medium supporting surface 18. In this configuration, the position and orientation of the print medium 14 can be registered by the alignment element 40 by guiding the print medium 14 against the alignment element 40.

The situation illustrated in FIG. 3 may correspond to a printing configuration, in which the alignment element 40 is raised relative to the print medium support surface 18 in the third direction Z by a distance greater than a thickness of the print medium 14 in the third direction Z, such that the alignment element 40 does not block a movement of the print medium 14 in the print medium movement direction Y through the printing device 10.

FIG. 4 schematically illustrates a vertical sectional view of the printing device 10 illustrated in FIG. 1 corresponding to a cut in the XZ-plane cut at a position in the Y-direction indicated in FIG. 1 by an arrow B. As illustrated in FIG. 4, the printhead 15 can print on the print medium 14 by firing the printing fluid on the print medium 14 from the printing nozzle arrays 12. In the example shown, the printhead 15 can scan across the print medium 14 in the printhead scanning direction X by moving the carriage 16 guided by the printhead bar 24 in the printhead scanning direction X.

The line sensor 26 can perform optical measurements on the print medium 14, for example to detect the edges of the print medium 14 and to detect image contrasts of an image printed on the print medium 14. In the example shown, the line sensor 26 moves with the carriage 16 to scan across the print medium 14 in the printhead scanning direction X. In other examples, the line sensor 26 may be independent from the carriage 16 and may in particular move in the printhead scanning direction X and/or in the print medium moving direction Y independently to scan across the print medium.

The control unit 30 may control the carriage 16 and the printhead 15 to print a reference mark on the print medium 14, the reference mark extending in the printhead scanning direction X. The reference mark may comprise a continuous line or a plurality of points or lines segments arranged along a line, which line may extend in the printhead scanning direction X from a first edge of the print medium 14 to a second opposite edge of the print medium 14; the line may also extend partly between the aforesaid first and second edges of the print medium 14. The reference mark may be printed on the print medium while the print medium 14 is not moving the print medium moving direction Y.

If a page wide printhead array is provided, the printhead 15 does possibly not move in the printhead scanning direction X to print the reference mark. In examples in which the carriage 16 is movable in the printhead scanning direction X, like in the example shown in FIGS. 1 to 4, the reference mark may be printed on the print medium 14 as the carriage 16 and the printhead 15 move in the printhead scanning direction X.

The reference mark may correspond to a projection of the scanning direction of the carriage 16 on the print medium 14 and hence reflect an alignment of the printhead scanning direction X.

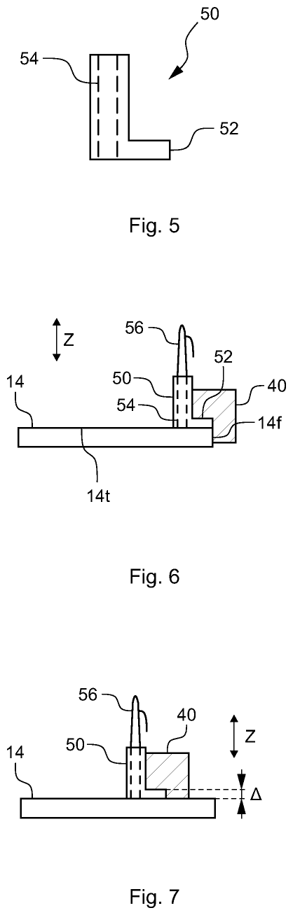

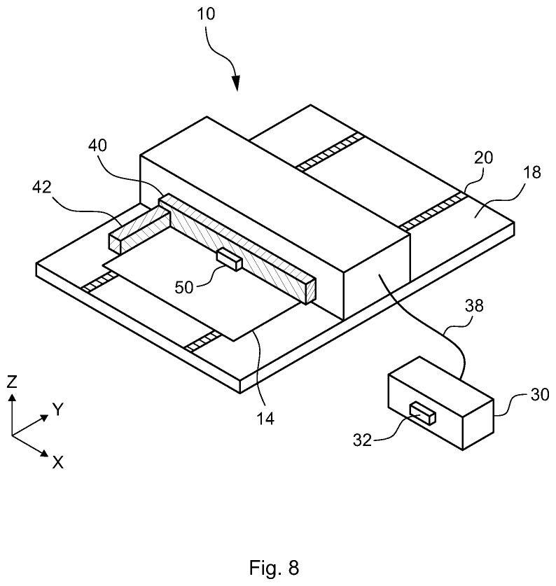

In some examples, the printing device 10 may further comprise a drawing device 50 to generate a calibration mark corresponding to a projection of the alignment element 40 upon the print medium 14. A drawing device 50 according to an example is schematically illustrated in FIGS. 5, 6 and 7. The drawing device 50 may comprise a body having an opening 54 formed therethrough, the opening to receive a drawing tool 56, and a protrusion 52 to guide a movement of the drawing device 50 on the print medium 14 against the alignment element 40. The drawing device 50 can be used to hold the drawing tool 56, such as a conventional pen, pencil or marker, therethrough, for example through an opening 54 formed in the drawing device 50, such that when the drawing device 50 is arranged on the print medium 14 to generate the calibration mark thereon, a drawing tip of the drawing tool 56 can reach the print medium 14 and print a mark thereon, as schematically shown in FIGS. 6 and 7. The drawing device 50 may be used to draw a calibration mark on the print medium 40 by sliding the drawing device 50 along the alignment element 40 while the drawing tool 56 contacts the print medium 14

The calibration mark may comprise a continuous line or a plurality of points or lines segments arranged on a line, which line may extend parallel to the alignment element 40 from a first edge of the print medium 14 to a second opposite edge of the print medium 14 or partly between the aforesaid first and second edges of the print medium 14.

According to some examples, the drawing device 50 may be a hand-held device independent from the alignment element 40. The alignment element 40 may in some examples comprise a slot or recess to receive and guide the protrusion 52. A dimension A of the protrusion 52 in the third direction Z may be selected so that the extension thereof in the Z-direction fits in said slot or recess formed in the alignment element 40. The protrusion 52 of the drawing device 50 may be inserted or insertable into and slidable within a gap between the alignment element 40 and the top surface of the print medium 14 in the third direction Z.

In other examples, the drawing device 50 may be removably or non-removably attached to the alignment element 40. The drawing device 50 may be 3D-printed or molded. In some examples, the drawing tool 56 may be an integral part of the drawing device 50 comprising an integrated drawing tool, such as a secondary print nozzle or print tip to print on the print medium 14, wherein the drawing device then does possibly not include any of an opening 54 to insert an independent drawing tool 56 and a protrusion 52.

FIG. 6 schematically illustrates a situation in which a drawing tool 56 is inserted into the drawing device 50 through the opening 54 and the protrusion 52 is inserted in a gap between the alignment element 40 and a top surface 14t of the print medium 14, wherein a front edge 14f of the print medium abuts against the alignment element 40. The drawing device 50 may then be used to draw a calibration mark on the print medium 40 by manually sliding the drawing device 50 against and along the alignment element 40 while pressing the drawing tool 56 against the print medium 14. Accordingly, the calibration mark corresponds to a projection of the alignment element 40 on the print medium 14. The alignment element 40 may guide the movement of the drawing device 50 along an extension of the alignment element 40.

FIG. 7 schematically illustrates a situation in which a drawing tool 56 is inserted into the drawing device 50 through the opening 54 and the protrusion 52 is inserted in a gap between the alignment element 40 and a top surface 14t of the print medium 14, wherein the alignment element abuts against the top surface 40 14t of the print medium 14, while the print medium 14 has partly advanced in the print medium movement direction Y past the alignment element 40 and a part of the print medium 14 is located below the printhead 15 for printing on the print medium. The drawing device 50 may then be used to draw a calibration mark on the print medium 40 by manually sliding the drawing device 50 against and along the alignment element 40 while holding the drawing tool 56 against the print medium 14.

FIG. 8 schematically illustrates a perspective view of a printing device 10 according to an example. Elements of a printing device 10 that have been described above with respect to FIGS. 1 to 7 are indicated in FIG. 8 using the same reference numerals and are not described again in detail for brevity. In the example illustrated in FIG. 8, the control unit 30 is an independent control unit, which may correspond to a personal computer or a laptop, which is functionally connected to the printing device 10 by means of the wired functional connection 38, for example an Ethernet connection.

A memory device 32 is connected to the control unit 30. The memory device 32 comprises program code which, when executed by a processor of the control unit 30, allows the control unit 30 to operate as a controller to implement a method of checking the alignment element 40 of the printing device 10. In other examples, the controller is possibly not in the form of program code or software-based and may instead be hardware-based, for example a hardware-based controller integrated within the control unit 30. The control unit 30 and the control module may be separate components in some examples, which are independently connected to the rest of the printing device 10.

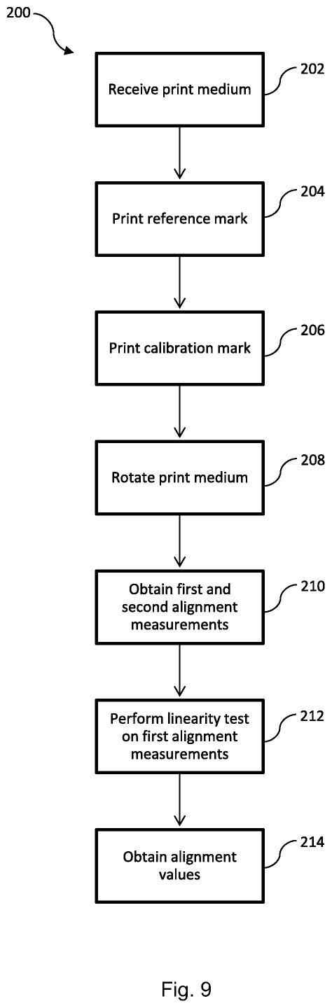

FIG. 9 shows a schematic flow diagram of a method 200 of checking the alignment element 40 according to an example, which may be implemented a printing device 10 according to any of the previously described examples, for example by a printing device controlled by the control unit 30 connected to the controller contained in the memory device 32 as illustrated in FIG. 8.

According to the method 200, in 202, a print medium 14 is received by the printing device 10. As shown in FIG. 8, the alignment element 40 and the lateral alignment element 42 may be used in 202 to register a position of the print medium 14 on the print medium support surface 18 of the printing device 10. The print medium 14 may be received in the printing device 10 in a marking orientation of the print medium 10, wherein the marking orientation may correspond to a first arrangement of the edges of the print medium 14 with respect to the alignment element 40. In some examples, in the marking orientation, if the print medium 14 has a rectangular shape, the longer edges of the print medium 14 may be substantially parallel to the alignment element 40 in the marking orientation.

In 204, the control unit 30 controls the printing device 10 to print, by means of the at least one printhead 15, a reference mark 60 on the print medium corresponding to a projection of the printhead scanning direction X on the print medium 14 as previously explained.

In 206, a calibration mark 62 corresponding to a projection of the alignment element 40 on the print medium 14 and hence extending in a longitudinal direction of the alignment element 40 may be printed on the print medium 14. The calibration mark 62 may be printed on the print medium 14 manually by a user, for example using a hand-held printing device 50 as previously explained with respect to FIGS. 5 to 7. In other examples, the calibration mark 62 may be printed out automatically by the printing device 10, for example by means of a printing device attached to the alignment element 40 and movable along the alignment element 40.

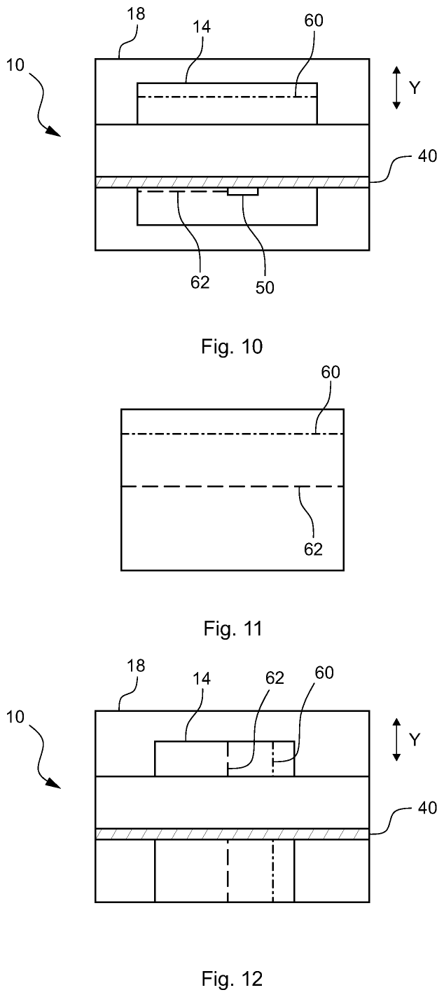

FIG. 10 schematically illustrates a print medium 14 received in a printing device 10 according to an example, wherein the reference mark 60 has already been printed on the print medium 14 by the printhead 15 of the printing device 10, and wherein the calibration mark 62 is being printed by the printing device 10 automatically by means of an integrated drawing device 50 moving in the longitudinal direction of the alignment element 40.

As illustrated in FIG. 10, the print medium 14 is received in the printing device 10 in a marking orientation of the print medium 14. In the marking orientation, the reference mark 60 is printed at a first position and the calibration mark 62 is printed at a second position, the second position and the first position being separated from each other in a direction substantially perpendicular to the printhead scanning direction X, i.e. in a direction substantially parallel to the print medium movement direction Y. The reference marks 60 and the calibration mark 62 may be printed in any order. In some examples, the print medium may be moved in the print medium movement direction Y, for example using the roller guides 20 of the example illustrated in FIG. 1, between printing the reference marks 60 and printing the calibration mark 62.

FIG. 11 schematically illustrates a print medium 14 after the reference mark 60 and the calibration mark 62 have been printed thereon. In some examples, the control unit 30 may control the printing device 10 to print the reference mark 60 by means of the printhead 15 at a predefined position on the print medium 14.

According to some examples, in 208, the print medium 14 may be rotated from the marking orientation illustrated in FIGS. 10 and 11 to a testing orientation different from the marking orientation. In some examples, in the testing orientation, the print medium 14 may be rotated by 90° with respect to the marking orientation. In some examples, if the print medium 14 has a rectangular shape and the longer edges of the print medium 14 are substantially parallel to the alignment element 40 in the marking orientation, the shorter edges of the print medium 14 may be substantially parallel to the alignment element 40 in the testing orientation, as schematically shown in FIG. 12.

As illustrated in FIG. 12, the print medium 14 may then be fed to the printing device 10 in the testing orientation.

With further reference to FIG. 9, in 210, with the print medium 14 in the testing orientation, the control unit 30 may measure, by means of the line sensor 26 of the printing device 10, first alignment measurements corresponding to positions of the reference mark 60 and second alignment measurements corresponding to positions of the calibration mark 62. In some examples, one of the first alignment measurements and one of the second alignment measurements may be obtained for each position of the print medium 14 in the print medium moving direction Y. The first and second alignment measurements may be optical measurements, for example color contrast or lightness contrast measurements, taken for different positions of the print medium 14 in the print medium moving direction Y as the print medium 14 moves in the print medium moving direction Y.

When the print medium 14 is in the testing orientation, an advancing of the print medium 14 in the print medium moving direction Y may be perpendicular to an advancing of the print medium 14 in the print medium moving direction Y when the print medium 14 is in the marking orientation, as regarded from the perspective of the print medium 14.

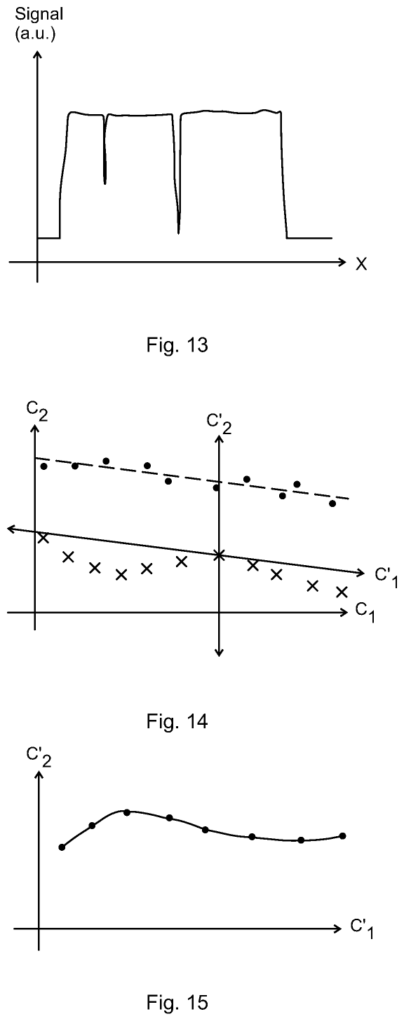

FIG. 13 schematically illustrates the result of an optical measurement performed by the line sensor 26 for a given position of the print medium 14 in the print medium moving direction Y, with the print medium 14 in the testing orientation, wherein a quantity of light received from the print medium 14 and measured by the line sensor 26 is represented (in arbitrary units) in the vertical axis as a function of position “x” on the print medium 14 along the printhead scanning direction X. The leftmost and rightmost step-like edges of the signal correspond to the edges of the print medium 14. The peaks located between said leftmost and rightmost edges of the signal correspond to respective first and second alignment measurements, which are indicative of the corresponding positions of the reference mark 60 and the calibration mark 62 on the print medium 14.

In some examples, when the line sensor 26 is movable in the print direction X, for example when the line sensor 26 is integrated in or attached to the carriage 16, the optical measurement illustrated in FIG. 13 may be obtained as the line sensor 26 moves in the printhead scanning direction X throughout the width of the print medium 14 (or of a sub-region thereof to be printed) in the printhead scanning direction X at a given position of the print medium 14 in the print medium moving direction Y.

In some examples, when the line sensor 26 extends in the printhead scanning direction X, e.g. when using a page wide line sensor, a signal like the signal illustrated in FIG. 13 may be obtained by the line sensor 26 as a single measurement at a given position of the print medium 14 in the print medium moving direction Y.

After the first and second alignment measurements have been obtained for a given position of the print medium 14 in the print medium moving direction Y, with the print medium in the testing orientation, the print medium 14 may be moved in the print medium moving direction Y to a new position, for example by means of the roller guides 20 or other equivalent mechanisms, and subsequent first and second alignment measurements may be obtained for said new position of the print medium 14 in the print medium moving direction Y.

The control unit 30 may control the printing device 10 to obtain the first and second alignment measurements according to predefined measurement settings, wherein the predefined measurement settings may determine the number of times the print medium 14 is moved in the print medium moving direction Y (number of steps) and the length by which the print medium 14 is moved in the print medium moving direction Y each time it is moved (step length).

In some examples, the control unit 30 may control the printing device 10 to obtain the first and second alignment measurements by means of the line sensor 26 by scanning the print medium 14 over an entire width of the print medium 14 in the printhead scanning direction X, when the print medium 14 is arranged in the testing orientation, or by scanning the print medium 14 over a part of the aforesaid width. In some examples, the control unit 30 may control the line sensor 26 to start obtaining measurements at a predefined position in the printhead scanning direction X, wherein said predefined position may correspond to an expected approximated position of the reference mark 60 or the calibration mark 62 on the print medium.

According to the method 200, after 210, a number of first alignment measurements and a number of second alignment measurements have been obtained. The first alignment measurements correspond to a projection of the printhead scanning direction X on the print medium 14. The second alignment measurements correspond to a projection of the alignment element 40 on the print medium 14.

In some examples, the method 200 may optionally comprise, at 212, performing a linearity test on the first alignment measurements. By performing the linearity test, the control unit 30 may identify whether the reference mark 60 and the first alignment measurements are such that the method 200 may allow properly checking the alignment element 60. Performing the linearity test may comprise at least one of calculating a linear regression for the first alignment measurements or a part thereof and calculating a Pearson correlation value for the first alignment measurements or a part thereof. If a result of the linearity test does not correspond to a predefined criterion, for example if the calculated Pearson correlation value is below a predefined threshold, for instance 95% or less, the method 200 may be aborted.

The method 200 further comprises, at 214, obtaining, by a processing unit of the control unit 30, at least one alignment value indicating an alignment of the longitudinal direction of the alignment element 40 with respect to the printhead scanning direction X based on the first and second alignment measurements obtained by the line sensor 26. The at least one alignment value may hence be indicative of a relative position and alignment of the second alignment measurements with respect to the first alignment measurements. Thereby, the at least one alignment value may reflect an alignment of the alignment element 40 with respect to the printhead scanning direction X.

As schematically illustrated in FIG. 14, the first and second alignment measurements may be obtained as value pairs expressed in terms of coordinates C₁ and C₂, respectively corresponding to positions in the printhead scanning direction X and in a direction perpendicular thereto. In FIG. 14, the first alignment measurements are represented as dots and the second alignment measurements are represented as crosses.

In some examples, obtaining the at least one alignment value may comprise performing a coordinate transformation on the second alignment measurements. The coordinate transformation may be such that new coordinates C₁′ and C₂′ are defined, respectively corresponding to a direction parallel to a direction defined by the first alignment measurements and a direction perpendicular to the printhead scanning direction X and parallel to the original coordinate C₂. The direction defined by the first alignment measurements may correspond to a linear regression obtained for the first alignment measurements or a subgroup thereof. In FIG. 14, the linear regression obtained for the first alignment measurements is illustrated as a dashed line.

The coordinate transformation to the new coordinates C₁′ and C₂′ may hence be expressed in terms of the original coordinates C₁, C₂ as

$$( \begin{matrix}{C}_{1}^{′} \\ {C}_{2}^{′}\end{matrix} ) = ( \begin{matrix}1 & 0 \\ - m & 1\end{matrix} ) ( \begin{matrix}{C}_{1} \\ {C}_{2}\end{matrix} ) = ( \begin{matrix}{C}_{1} \\ - {mC}_{1} + {C}_{2}\end{matrix} ) ,$$

with m being the slope of the linear regression obtained for the first alignment measurements, e.g. the slope of the dashed line shown in FIG. 14. Thereby, the new coordinates C₁′, C₂′ express a position of each second alignment measurement in a direction parallel to a direction defined by the first alignment measurements, i.e. parallel to the dashed line shown in FIG. 14 and in a direction perpendicular to the printhead scanning direction X. Thus, C₁′ may be parallel to the direction defined by the first alignment measurements and C₂′ may be perpendicular to the printhead scanning direction X, i.e. parallel to C₂, as shown in FIG. 14.

The coordinate transformation may further comprise setting as an origin of coordinates the position of a second alignment measurement having a minimal distance to the first alignment measurements. In other words, the origin of the coordinate system may be shifted by means of the coordinate transformation to a point of minimum distance between the second alignment measurements and the first alignment measurements, as shown in FIG. 14.

If the position of the second alignment measurement closest to the first alignment measurements is, in terms of the original coordinates C₁, C₂, a position (C₁*, C₂*), the coordinate transformation to the new coordinates X′ and Y′ may be implemented as follows:

$$( \begin{matrix}{C}_{1}^{′} \\ {C}_{2}^{′}\end{matrix} ) = ( \begin{matrix}1 & 0 \\ - m & 1\end{matrix} ) ( \begin{matrix}{C}_{1}^{*} - {C}_{1} \\ {C}_{2}^{*} - {C}_{2}\end{matrix} ) = ( \begin{matrix}{C}_{1}^{*} - {C}_{1} \\ - m ( {C}_{1}^{*} - {C}_{1} ) + ( {C}_{2}^{*} - {C}_{2} )\end{matrix} )$$

By means of such coordinate transformation, the alignment values defined by the coordinates C₁′, C₂′ for each of the points corresponding to the second alignment measurements intrinsically reflect the alignment of the alignment element 40 with respect to the reference mark 60, i.e. with respect to the printhead scanning direction X as well as a curvature of the alignment element 40 with respect to the reference mark 60, i.e. with respect to the printhead scanning direction X, as illustrated in FIG. 15.

The method is not sensitive to a given orientation of the print medium 14 when the first and second alignment elements are obtained by the line sensor, nor is it sensitive to an alignment of each of the reference mark 60 and the calibration mark 62 with respect to the print medium 14.

When expressed in the new coordinates, the positions of the second alignment measurements correspond to the alignment values and are indicative of an alignment, orientation and curvature of the alignment element 40 with respect to the reference mark 60 at each point corresponding to an alignment measurement.

Thus, the control unit 30 obtains, by means of the obtained alignment values, a deviation of a direction defined by the calibration mark 62 from an alignment defined by the reference mark 60, i.e. an alignment of the longitudinal direction of the alignment element 40 with respect to the printhead scanning direction X, based on the first and second alignment measurements. Thereby, an alignment of the alignment element 40 with respect to the printhead scanning direction X may be checked using the obtained alignment values.

In some examples, the method 200 may further comprise outputting the alignment values, for example by printing or displaying the alignment values, for example in the form of a plot illustrated in FIG. 15, such that the alignment values can be taken into account for readjusting an alignment of the alignment element 40. In some examples, the user may manually correct an alignment of the alignment element 40 accordingly. In some examples, the printing device may automatically determine whether there is a misalignment of the alignment element 40 and, in such case, correct an alignment of the alignment element 40.

The controller implemented by the program code stored in the memory device 32 may obtain, from the line sensor 26 of the printing device 10, the first alignment measurements corresponding to positions of a reference mark 60 printed on the print medium 14 and the second alignment measurements corresponding to positions of a calibration mark 62 printed on the print medium 14. The controller may then obtain alignment values corresponding to a deviation of a direction defined by the calibration mark 62 from an alignment defined by the reference mark 60.

The method 200 allows using the printing device 10 as a metrology tool to determine whether the alignment element 40 is misaligned or not with respect to the printhead scanning direction X. An alignment of the alignment element 40 is determined by comparing a relative alignment of the calibration mark 62 with respect to the reference mark 60. The method 200 allows identifying in a simple and reliable manner, without depending on a precise orientation of the print medium 16 used for testing, whether the alignment element 40 is misaligned and provides information for readjusting the alignment element 40 if necessary. The method is implementable in existing printers.

1. A method of checking an alignment element of a printer, the method comprising:
receiving, by the printer, a print medium,
printing on the print medium, by a printhead of the printer, a reference mark extending in a printhead scanning direction,
printing on the print medium a calibration mark extending in a longitudinal direction of the alignment element,
obtaining, by a sensor of the printer, first alignment measurements corresponding to positions of the reference mark and second alignment measurements corresponding to positions of the calibration mark, and
obtaining, by a processing unit, at least one alignment value indicating an alignment of the longitudinal direction of the alignment element with respect to the printhead scanning direction based on the first and second alignment measurements.

2. The method of claim 1, wherein at least one of the reference mark and the calibration mark comprises a continuous line or a plurality of points or line segments arranged on a line extending between edges of the print medium.

3. The method of claim 1, wherein receiving the print medium includes receiving the print medium with a marking orientation of the print medium, wherein in the marking orientation, the reference mark is printed at a first position and the calibration mark is printed at a second position, wherein the second position is different from the first position in a direction perpendicular to the printhead scanning direction.

4. The method of claim 3, wherein the method further comprises, after printing the reference mark and the calibration mark and before obtaining the first and second alignment measurements, rotating the print medium to a testing orientation different from the marking orientation.

5. The method of claim 1, wherein the calibration mark is printed on the print medium using a hand-held drawing device.

6. The method of claim 1, wherein obtaining the alignment values comprises performing a coordinate transformation on the second alignment measurements such that new coordinates are defined, respectively corresponding to a direction parallel to a direction defined by the first alignment measurements and a direction perpendicular to the printhead scanning direction.

7. The method of claim 1, further comprising, after obtaining the first and second alignment measurements and before obtaining the at least one alignment value, performing a linearity test on the first alignment measurements.

8. A printing device comprising:
a printhead to print a print medium, wherein the printhead is movable or extends in a printhead scanning direction,
an alignment element extending in a direction substantially parallel to the printhead scanning direction to register a position of the print medium when the print medium is received by the printing device,
a line sensor to perform optical measurements on the print medium,
a control unit to:
measure, by means of the line sensor, a reference mark printed on the print medium and a calibration mark printed on the print medium,
obtain at least one alignment value corresponding to a deviation of a direction defined by the calibration mark from a direction defined by the reference mark, and
test an alignment of the alignment element with respect to the printhead scanning direction using the obtained alignment values.

9. The printing device of claim 8, wherein the control unit further is to control the printhead to print the reference mark on the print medium, wherein the reference mark extends on the print medium in the printhead scanning direction.

10. The printing device of claim 8, further comprising a drawing device to print the calibration mark corresponding to a projection of the alignment element upon the print medium.

11. The printing device of claim 10, wherein the drawing device is a hand-held drawing device.

12. The printing device of claim 8, wherein the line sensor is movable in the printhead scanning direction to scan the print medium.

13. The printing device of claim 8, wherein the line sensor extends in the printhead scanning direction to scan the print medium.

14. A calibration module for a printing device including a controller to:
obtain, from a sensor device of the printing device, first alignment measurements corresponding to positions of a reference mark printed on the print medium and second alignment measurements corresponding to positions of a calibration mark printed on the print medium, and
obtain alignment values corresponding to a deviation of a direction defined by the calibration mark from an alignment defined by the reference mark.

15. The module of claim 14, wherein, when obtaining the first and second alignment measurements, the reference mark and the calibration mark are printed on the print medium in a direction extending perpendicularly to a printhead scanning direction of a printhead of the printing device.
